(19) United States
(12) Patent Application Publication
(10) Pub. No.: US 2007/0019122 A1
(43) Pub. Date: Jan. 25, 2007

(54) Array substrate for display device

(75) Inventors: In-Sung Lee, Seoul (KR); Neugng-Ho Cho, Suwon-si (KR); Dong-Hoon Lee, Seoul (KR); Youn-Soo Choi, Seongnam-si (KR); Ho-Geun Choi, Suwon-si (KR); Jin-Chel Choi, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/490,758

(22) Filed: Jul. 20, 2006

(30) Foreign Application Priority Data
Jul. 20, 2005 (KR) 2005-65828
Oct. 24, 2005 (KR) 2005-100045

(51) Int. Cl. G02F 1/136

(52) U.S. Cl. 349/43

(57) ABSTRACT

A substrate for an LCD display device exhibiting improved display quality through lower contact resistance and elimination of undercutting. The display switches have three electrodes, at least one of which has three metal layers, the third of which is formed by nitrating the second metal layer. The pixel electrode is electrically connected to the second metal layer through a contact hole formed through an insulation layer and the second metal layer of the switching device.

### CROSS-REFERENCE TO RELATED APPLICATIONS

This application relies for priorities upon Korean Patent Application No. 2005-65828 filed on Jul. 20, 2005 and Korean Patent Application No. 2005-100045 filed on Oct. 24, 2005, the contents of which are herein incorporated by reference in their entirety.

### BACKGROUND OF THE INVENTION

1. Field of the Invention

The present invention relates to an array substrate, a method of manufacturing the array substrate and a display device having the array substrate. More particularly, the present invention relates to an array substrate having an improved display quality, a method of manufacturing the array substrate having the improved display quality, and a display device having the array substrate having the improved display quality.

2. Description of the Related Art

Generally, a liquid crystal display (LCD) device includes an array substrate, a color filter substrate facing the array substrate, and a liquid crystal layer interposed between the array substrate and the color filter substrate. The array substrate has a plurality of pixels each of which contains a gate line provided with a gate signal, a data line provided with a data signal, a thin film transistor (TFT) electrically connected to the gate line and the data line, and a pixel electrode which receives the data signal and applies voltages to the liquid crystal layer. Each of electrodes of the TFT, the gate line and the data line has a double-layered structure in order to reduce contact resistance with the pixel electrode and line resistance. The first layer includes aluminum neodymium and the second layer including chrome stacked on the first layer. When patterning the first and the second layers in order to form the electrodes, the gate line and the data line are affected by an undercut phenomenon, which means the first layer is more etched than the second layers. A local charge trapping effect occurs in which electrons concentrate on the area where the undercut phenomenon occurs. Thus, the capacitance of the insulation layer formed on the second layer increases, changing the pixel voltage and its brightness.

### SUMMARY OF THE INVENTION

In accordance with the invention, an array substrate has a triple-layered structure including aluminum neodymium, chrome and chrome nitride which prevens undercutting during the patterning of the electrodes, gate lines and data lines so that undesired etching of layers is eliminated and contact resistance between a layer and the pixel electrode is reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is a cross-sectional view illustrating an LCD panel in accordance with an example embodiment of the present invention;

FIG. 2 is a plan view illustrating an array substrate shown in FIG. 1;

FIG. 3 is a cross-sectional view illustrating a gate electrode shown in FIG. 1;

FIGS. 4A to 4G are cross-sectional views illustrating steps for forming the array substrate shown in FIG. 2;

FIG. 5 is a cross-sectional view illustrating a reactive sputtering apparatus for forming the third metal layer shown in FIG. 4B;

FIG. 6 is a cross-sectional view illustrating a PCVD apparatus for forming the third metal layer shown in FIG. 4B;

FIGS. 7A to 7G are cross-sectional views illustrating steps for forming the array substrate shown in FIG. 1;

FIG. 8 is a cross-sectional view illustrating etching baths for etching the first, the second metal and the third metal layers shown in FIG. 7C; and

FIG. 9 is an exploded prospective view illustrating an LCD device having an LCD panel in accordance with an example embodiment of the present invention.

### GENERAL DESCRIPTION

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. Spatially relative terms are intended to encompass different orientations of the device in use or operation in addition to the orientation depicted in the figures. The regions illustrated in the figures are schematic in nature and their shapes are not intended to illustrate the actual shape of a region of a device and are not intended to limit the scope of the invention.

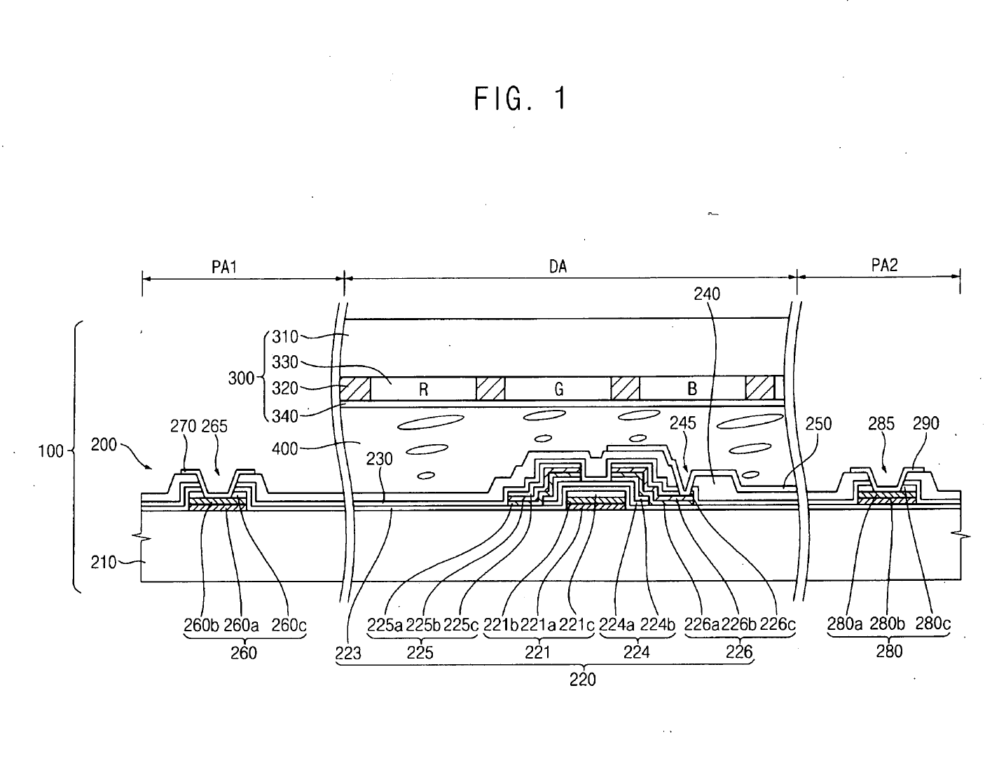

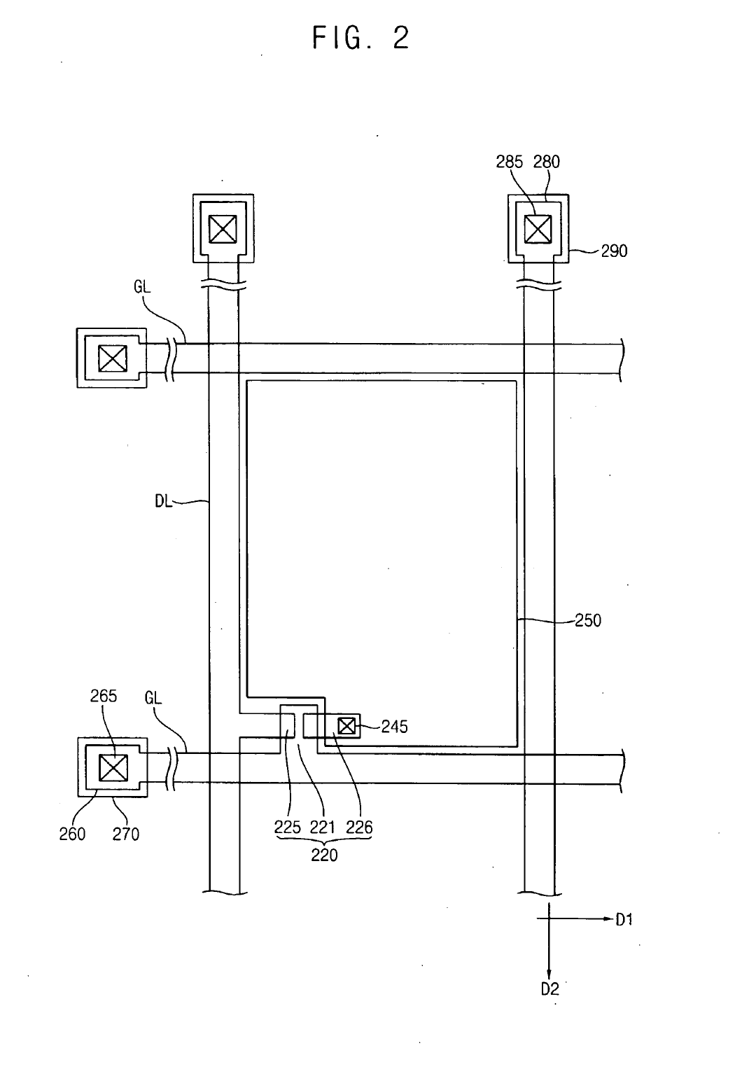

Referring to FIGS. 1 to 2, an LCD panel 100 includes an array substrate 200, a color filter substrate 300 and a liquid crystal layer 400 formed between the array substrate 200 and the color filter substrate 300, and the LCD panel 100 displays images. LCD panel 100 includes a display area DA in which the images are displayed, a first peripheral area PA1 that is located at a first portion of the LCD panel surrounding the display area DA and a second peripheral area PA2 that is located at a second portion of the LCD panel surrounding the display area DA. The first portion of the LCD panel around the display area DA is a portion along a first side of the LCD panel, and the second portion of the LCD panel around the display area DA is a portion along a second side of the LCD panel which is substantially perpendicular to the first side of the LCD panel. In the display area DA, a plurality of pixel regions is defined by a plurality of gate lines GL extending in a first direction D1 and a plurality of data lines DL extending in a second direction D2 that is substantially perpendicular to the first direction D1.

The array substrate 200 includes a thin film transistor (TFT) 220, a protecting layer 230, an organic insulation layer 240 and a pixel electrode 250, all of which are formed on a first insulation substrate 210. The TFT 220 and the pixel electrode 250 are formed in a pixel region positioned in the display area DA. TFT 220 includes a gate electrode 221 branched off from the gate line GL, a source electrode 225 branched off from the data line DL, and a drain electrode 226 electrically connected to the pixel electrode 250. In addition, TFT 220 includes a gate insulation layer 223 formed on the gate electrode 221 and an active layer 224. Each of the gate electrode 221, the source electrode 225 and the drain electrode 226 has a triple-layered structure. Particularly, the gate electrode 221 has a first gate electrode layer 221a, a second gate electrode layer 221b stacked on the first gate electrode layer 221a, and a third gate electrode layer 221c stacked on the second gate electrode layer 221b. The first gate electrode layer 221a may include aluminum neodymium (AlNd), the second gate electrode layer 221b may include chrome (Cr), and the third gate electrode layer 221c may include chrome nitride (CrNₓ), which is nitrated from the chrome (Cr) included in the second gate electrode layer 221b.

Source electrode 225 has a first source electrode layer 225a, a second source electrode layer 225b stacked on the first source electrode layer 225a, and a third source electrode layer 225c stacked on the second source electrode layer 225b. The first source electrode layer 225a may include aluminum neodymium (AlNd), the second source electrode layer 225b may include chrome (Cr), and the third source electrode layer 225c may include chrome nitride (CrNₓ) that is nitrated from the chrome (Cr) included in the second source electrode layer 225b.

Drain electrode 226 has a first drain electrode layer 226a, a second drain electrode layer 226b stacked on the first drain electrode layer 226a, and a third drain electrode layer 226c stacked on the second drain electrode layer 226b. The first drain electrode layer 226a may include aluminum neodymium (AlNd), the second drain electrode layer 226b may include chrome (Cr), and the third drain electrode layer 226c may include chrome nitride (CrNₓ) that is nitrated from the chrome (Cr) included in the second drain electrode layer 226b. Each of the gate electrode 221, the source electrode 225 and the drain electrode 226 has a taper-shaped cross section along a cut line perpendicular to the first insulation substrate 210. That is, none of the gate electrode 221, the source electrode 225 and the drain electrode 226 has an undercut shaped cross section.

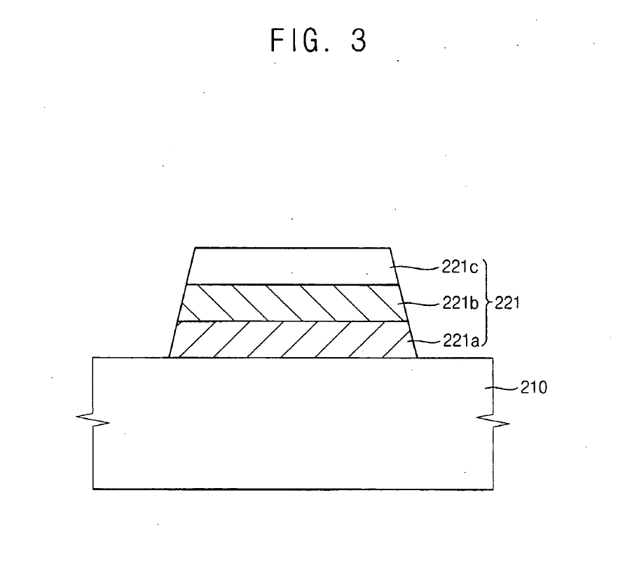

Referring to FIG. 3, the cross section of the gate electrode 221 along the cut line perpendicular to the first insulation substrate 210 has a relatively wider lower portion than an upper portion. Thus, the gate electrode 221 has the taper-shaped cross section. Similarly, both of the source electrode 225 and the drain electrode 226 have the taper-shaped cross sections. All of the first gate electrode layer 221a of the gate electrode 221, the first source electrode layer 225a of the source electrode 225 and the first drain electrode layer 226a of the drain electrode 226 include aluminum neodymium (AlNd) so that no undercut phenomenon occurs in the gate electrode 221, the source electrode 225 and the drain electrode 226, as is explained in detail later. Therefore, electrons do not concentrate at a portion that the undercut phenomenon occurs, i.e., local charge trapping does not occur so that capacitance of an insulation layer formed on the gate electrode 221 does not increase. Thus, changes of a pixel voltage due to the increase of the capacitance of the insulation layer do not occur so that display failure such as occurrence of lateral stripes according to changes of brightness may be prevented.

Gate insulation layer 223 is formed on the first insulation substrate 210 where the gate electrode 221 is formed. The gate insulation layer 223, for example, includes silicon nitride (SiNₓ). The active layer 224 is formed on the gate insulation layer 223. The active layer 224 includes a semiconductor film 224a and an ohmic contact film 225b stacked on the semiconductor film 224a. For example, the semiconductor film 224a may include amorphous silicon (a-Si) and the ohmic contact film 224b may include amorphous silicon heavily doped with N-type impurities (n⁺ a-Si). The ohmic contact film 224b is partially removed from the first insulation substrate 210 to thereby partially expose the semiconductor film 224a.

Protecting layer 230 and the organic insulation layer 240 are sequentially formed on the first insulation substrate 210 where the TFT 220 is formed. In addition, the protecting layer 230 and the organic insulation layer 240 are formed in all of the display area DA and the first and the second peripheral areas PA1 and PA2. The protecting layer 230 and the organic insulation layer 240, for example, may include silicon nitride. Further, the protecting layer 230 and the organic insulation layer 240 have a contact hole 245 partially exposing the drain electrode 226.

Protecting layer 230 and the organic insulation layer 240 are partially removed from the first insulation substrate 210 to expose the drain electrode 226. While the protecting layer 230 and the organic insulation layer 240 are removed, the third drain electrode layer 226c of the drain electrode 226 is simultaneously removed from the first insulation substrate 210 by an etching liquid, which is used to etch the protecting layer 230 and the organic insulation layer 240. Accordingly, the second drain electrode layer 226b of the drain electrode 226 is partially exposed.

Pixel electrode 250 is formed on the organic insulation layer 240. The pixel electrode 250 may include a transparent material through which light may transmit. For example, the pixel electrode 250 includes indium zinc oxide (IZO) or indium tin oxide (ITO). The pixel electrode 250 is electrically connected to the drain electrode 226 through the contact hole 245. Particularly, the pixel electrode 250 directly makes contact with the second drain electrode layer 226b of the drain electrode 226. When the second drain electrode layer 226b includes pure chrome, contact resistance between the second drain electrode layer 226b and the pixel electrode 250 may be reduced.

Both gate line GL and the data line DL have triple-layered structures. In an example embodiment of the present invention, each of the gate line GL and the data line DL has a first layer including aluminum neodymium, a second layer including chrome, and a third layer including chrome nitride. Gate electrode pad 260, which is extended from the gate line GL and has a wider width than the gate line GL, is formed in the first peripheral area PA1. The gate electrode pad 260 includes a first gate electrode pad layer 260a, a second gate electrode pad layer 260b stacked on the first gate electrode pad layer 260a, and a third gate electrode pad layer 260c stacked on the second gate electrode pad layer 260b. In an example embodiment of the present invention, the gate electrode pad 260 is formed in the process for forming the gate electrode 221 using substantially the same material as the material used in forming the gate electrode 221. Accordingly, for example, the first gate electrode pad layer 260a may include aluminum neodymium, the second gate electrode pad layer 260b may include chrome, and the third gate electrode pad layer 260c may include chrome nitride.

A first via hole 265 is formed in the first peripheral area PA1 to partially expose the gate electrode pad 260. Particularly, the organic insulation layer 240, the protecting layer 230, the gate insulation layer 223 on the gate electrode pad 260 and the third gate electrode pad layer 260c are partially removed to thereby form the first via hole 265. A first transparent electrode 270 is formed over the gate electrode pad 260 to be electrically connected to the gate electrode pad 260 through the first via hole 265. Particularly, the first transparent electrode 270 directly makes contact with the second gate electrode pad layer 260b through the first via hole 265. In an example embodiment of the present invention, the first transparent electrode 270 is formed in the process for forming the pixel electrode 250 using substantially the same material as the material used in forming the pixel electrode 250. That is, the first transparent electrode 270 may include ITO or IZO. When the second gate electrode pad layer 260b includes pure chrome, contact resistance between the first transparent electrode 270 and the second gate electrode pad layer 260b may be reduced.

A data electrode pad 280 extended from the data line GL and having a wider width than the data line DL is formed in the second peripheral area PA2. The data electrode pad 280 includes a first data electrode pad layer 280a, a second data electrode pad layer 280b stacked on the first data electrode pad layer 280a, and a third data electrode pad layer 280c stacked on the second data electrode pad layer 280b. Data electrode pad 280 is formed in the process for forming the data electrode 225 using substantially the same material as the material used in forming the data electrode 225. Accordingly, for example, the first data electrode pad layer 280a may include aluminum neodymium, the second data electrode pad layer 280b may include chrome, and the third data electrode pad layer 280c may include chrome nitride.

A second via hole 285 is formed in the first peripheral area PA2 to partially expose the data electrode pad 280. Particularly, the organic insulation layer 240, the protecting layer 230 on the gate electrode pad 260 and the third data electrode pad layer 280c are partially removed to thereby form the second via hole 285. A second transparent electrode 290 is formed over the data electrode pad 280 to be electrically connected to the data electrode pad 280 through the second via hole 285. Particularly, the second transparent electrode 290 directly makes contact with the second data electrode pad layer 280b through the second via hole 285. In an example embodiment of the present invention, the second transparent electrode 290 is formed in the process for forming the pixel electrode 250 using substantially the same material as the material used in forming the pixel electrode 250. That is, the second transparent electrode 290 may include ITO or IZO. When the second data electrode pad layer 280b includes pure chrome, contact resistance between the second transparent electrode 290 and the second data electrode pad layer 280b may be reduced.

Gate electrode pad 260 and the data electrode pad 280 may be electrically connected to a flexible printed circuit board (FPCB) (not shown) through an anisotropic conductive film (ACF) (not shown) to output gate signals and data signals input from the FPCB to the gate line GL and the data line DL, respectively.

The color filter substrate 300 includes a second insulation substrate 310, a light-shielding layer 320, a color filter layer 330 and a common electrode 340. The light-shielding layer 320 and the color filter layer 330 are formed on the second insulation substrate 310, and the common electrode 340 is formed on the light-shielding layer 320 and the color filter layer 330. The color filter layer 330 includes three sub color filter layers R, G and B, each of which includes a red color pixel, a green pixel and a blue color pixel, respectively. The light-shielding layer 320 is formed as a matrix type, and prevents light from leaking among the three sub color filter layers R, G and B. In the meantime, the common electrode 340 is formed to face the pixel electrode 250 on the array substrate 200.

In an example embodiment of the present invention, each of the gate electrode 221, the source electrode 225, the drain electrode 226, the gate electrode pad 260 and the data electrode pad 280 is formed to have a triple-layered structure by a reactive sputtering process. In another example embodiment of the present invention, each of the gate electrode 221, the source electrode 225, the drain electrode 226, the gate electrode pad 260 and the data electrode pad 280 is formed to have a triple-layered structure by a plasma chemical vapor deposition (PCVD) process.

All of the gate electrode 221, the source electrode 225, the drain electrode 226, the gate electrode pad 260 and the data electrode pad 280 may be formed by etching a triple-layered structure including aluminum neodymium, chrome and chrome nitride. Etching the triple-layered structure may be performed by a plurality of etching processes. Alternatively, etching the triple-layered structure may be performed by one etching process. In an example embodiment of the present invention, the triple-layered structure is etched by one etching process using a mixture of etching solutions including a first etching solution for chrome and chrome nitride and a second etching solution for aluminum neodymium.

The first etching solution includes ceric ammonium nitrate (CAN) and nitric acid (HNO₃), and the second etching solution includes ammonium fluoride (NH₄F). The mixture of etching solutions includes about 5 to about 30 percent by weight of CAN and about 2 to about 20 percent by weight of nitric acid. CAN and nitric acid do not react with each other. In addition, the mixture of etching solutions further includes about 1 to about 5 percent by weight of formic acid or acetic acid. Ammonium fluoride included in the mixture of etching solutions may etch a first metal layer including aluminum neodymium, and CAN and nitric acid included in the mixture of etching solutions may etch a second metal layer including chrome and a third layer including chrome nitride. Accordingly, the gate electrode 221, the source electrode 225, the drain electrode 226, the gate electrode pad 260 and the data electrode pad 280 each of which has the triple-layered structure may be formed. In the above-mentioned process, the first metal layer including aluminum neodymium may be more etched than the second and the third metal layers including chrome and chrome nitride, respectively, due to the galvanic effect. That is, the triple-layered structure including the etched first, the etched second and the etched third metal layers has an over-hang structure in which an upper portion is wider than a lower portion. Here, the galvanic effect means that when two different metals are etched making contact with each other, a metal having relatively lower potential becomes an anode to be etched relatively faster.

Thus, an etching process using nitric acid may be performed once more to etch the second and the third metal layers that are more protruded than the first metal layer. Accordingly, each of the gate electrode 221, the source electrode 225, the drain electrode 226, the gate electrode pad 260 and the data electrode pad 280 may have a taper-shaped cross section along a cut line substantially perpendicular to the first insulation substrate 210.

According to the example embodiment of the present invention, the number of processes for manufacturing the display panel may be reduced by etching the triple-layered structure included in the display panel using the mixture of etching solutions. That is, conventionally, in order to pattern the triple-layered structure, processes for patterning the second and the third metal layers including chrome nitride and chrome such as a photoresist deposition process, an exposure process, a development process, an etching process, etc., are performed. Then, processes for patterning the first metal layers including aluminum neodymium such as a photoresist deposition process, an exposure process, a development process, an etching process, etc., are performed. Thus, the conventional process for patterning the triple-layered structure has been very complicated. However, according to the example embodiment of the present invention, the triple-layered structure is patterned by one process using the mixture of etching solutions so that the number of processes for manufacturing the display panel including the triple-layered structure may be reduced.

Example 1 of a Method of Forming an Array Substrate

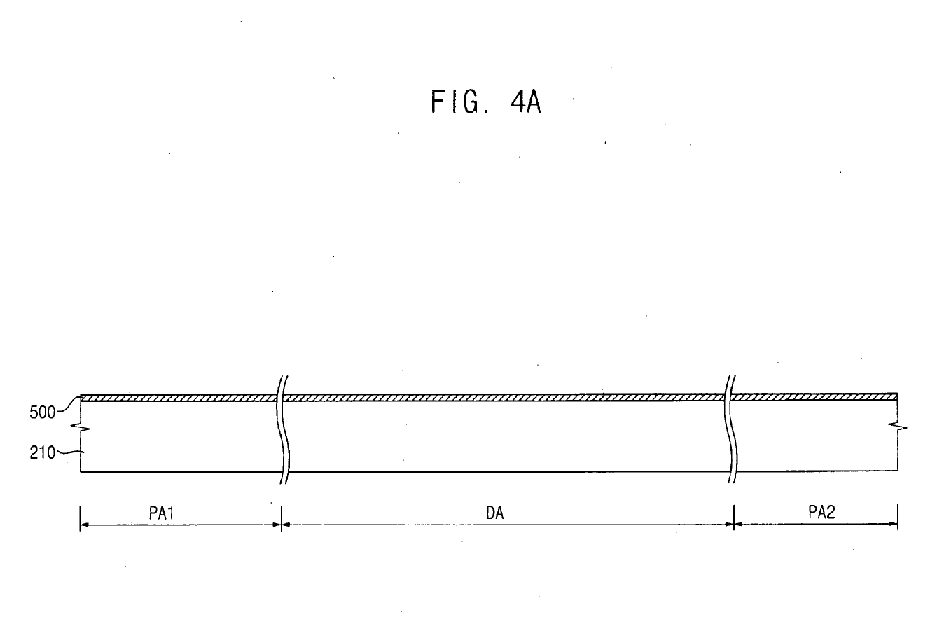

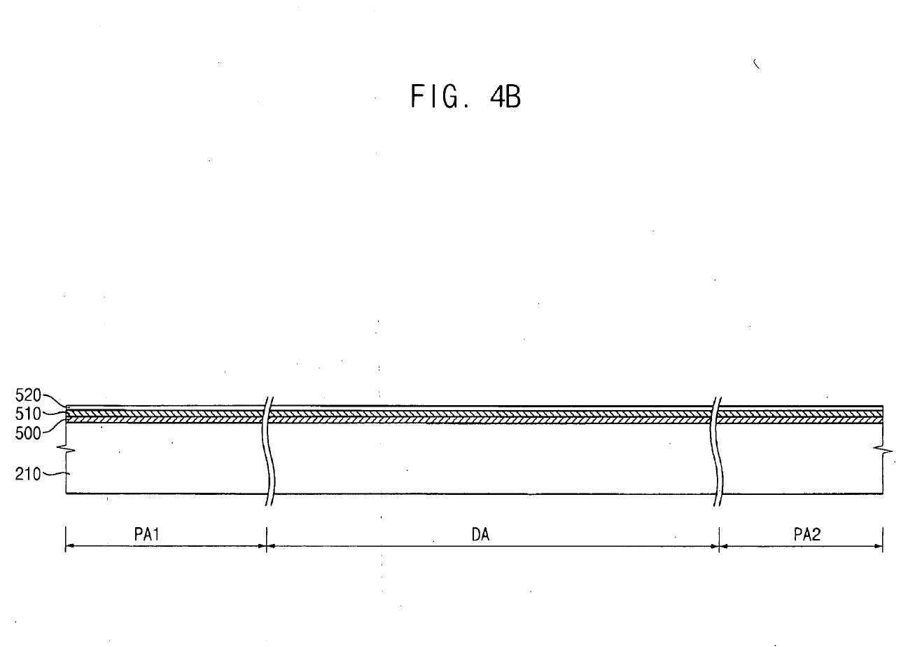

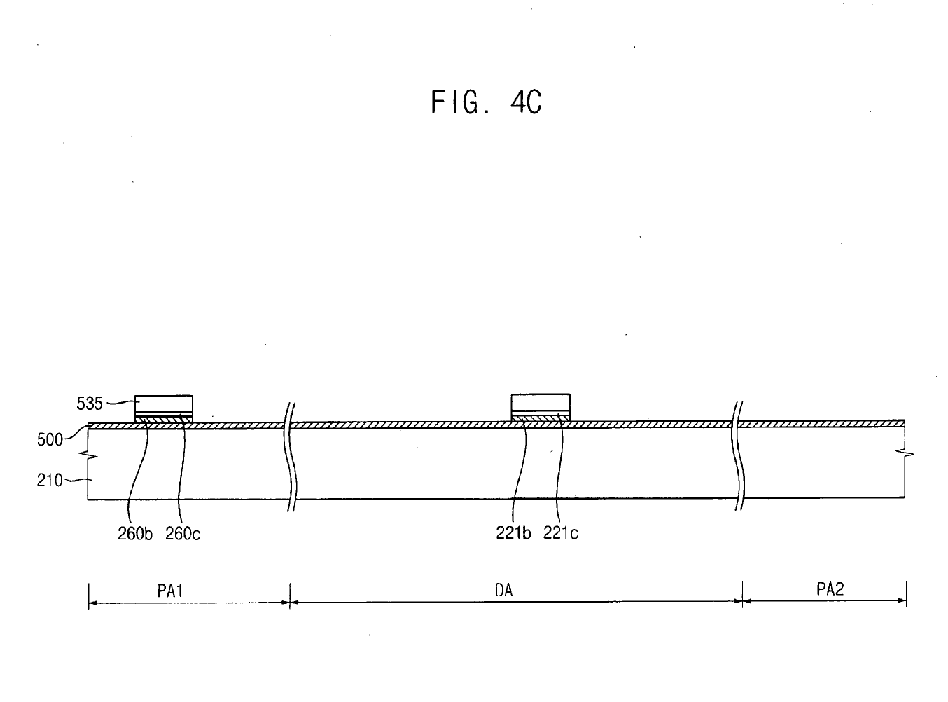

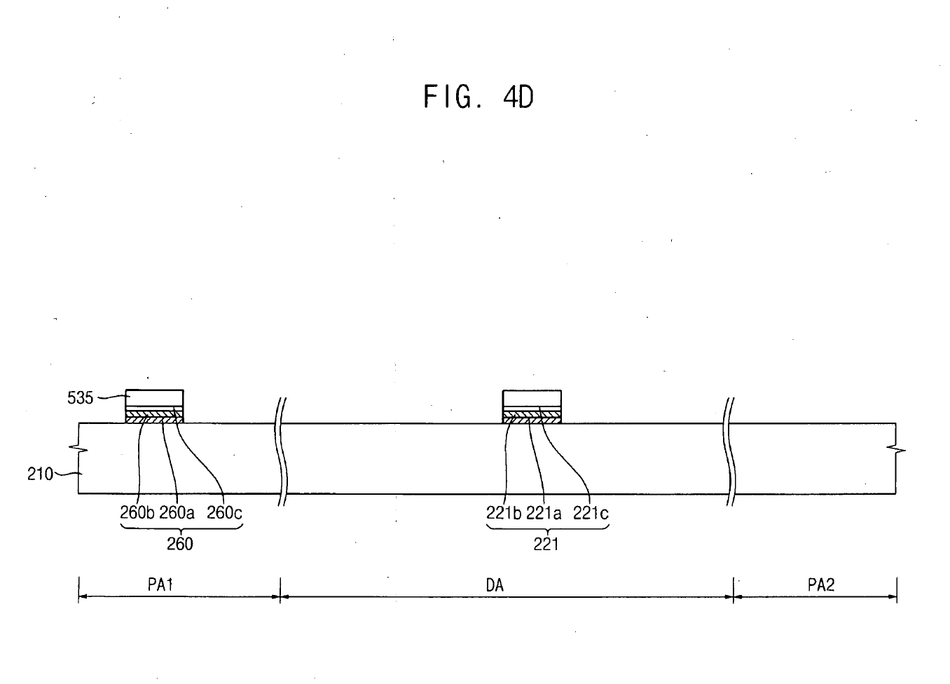

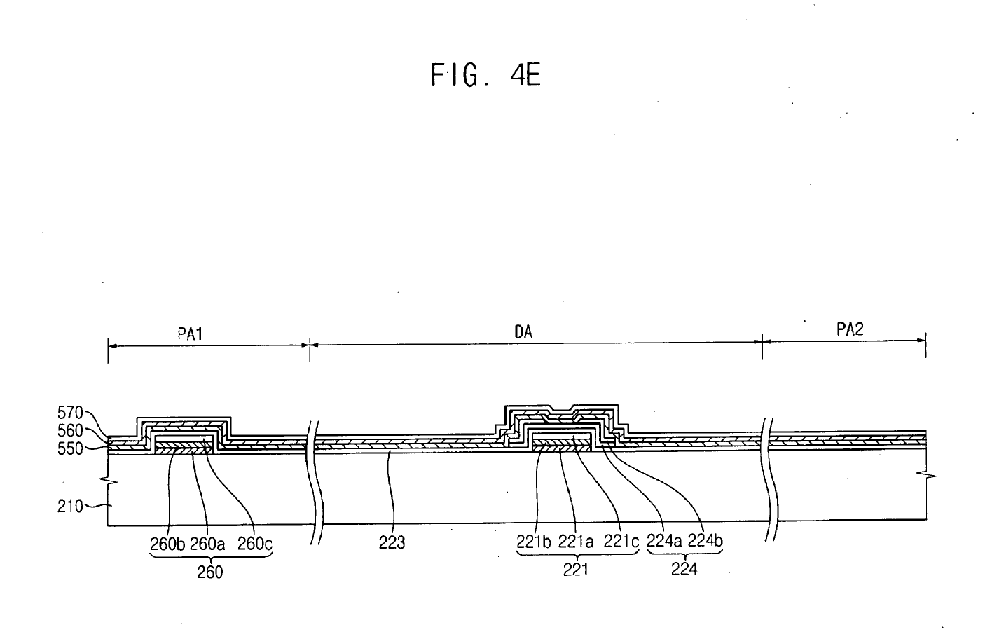

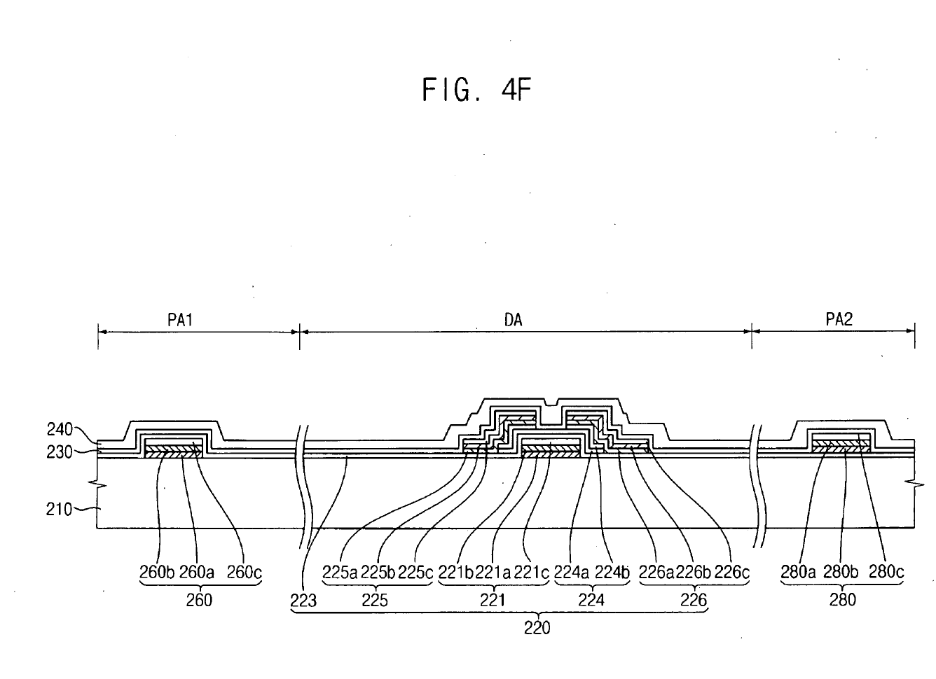

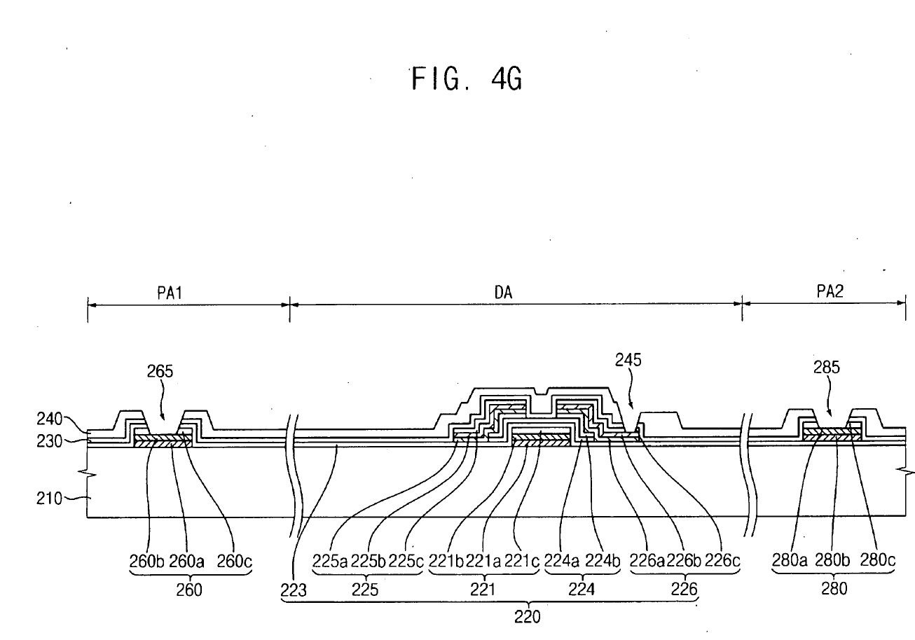

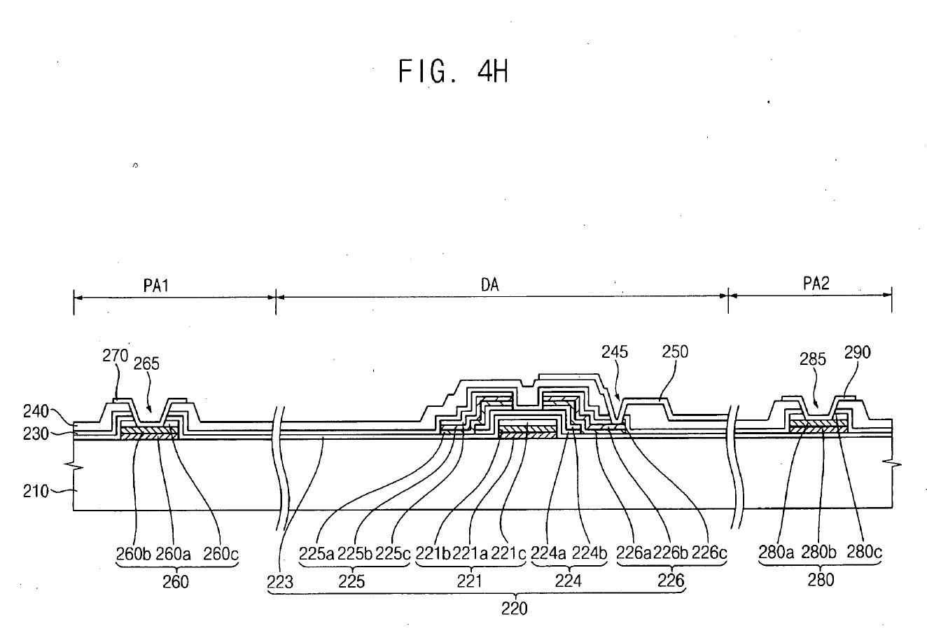

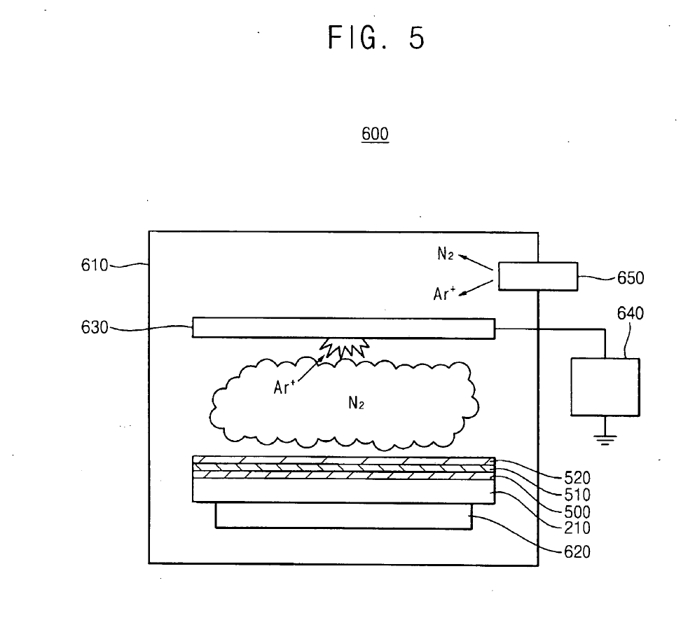

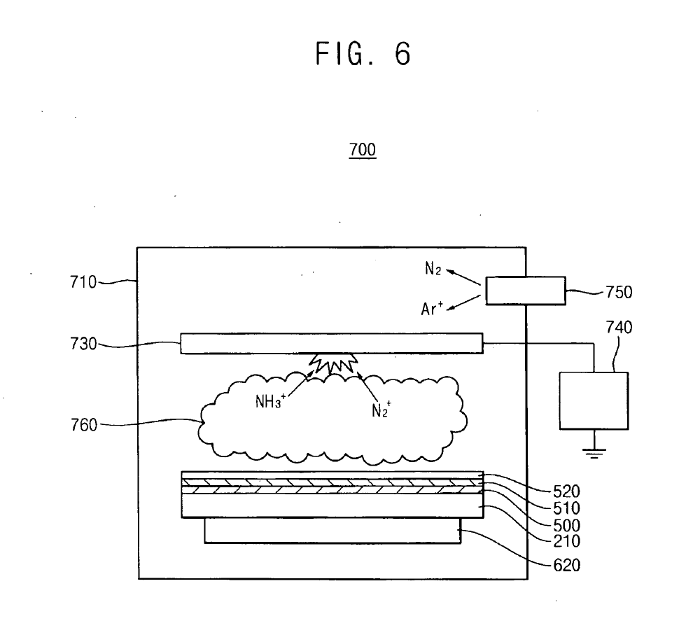

FIGS. 4A to 4G are cross-sectional views illustrating steps for forming the array substrate shown in FIG. 2, FIG. 5 is a cross-sectional view illustrating a reactive sputtering apparatus for forming the third metal layer shown in FIG. 4B, and FIG. 6 is a cross-sectional view illustrating a PCVD apparatus for forming the third metal layer shown in FIG. 4B. Referring to FIG. 4A, a first metal layer 500 is formed on a first insulation substrate 210. The first metal layer 500 may be formed using aluminum neodymium. In an example embodiment of the present invention, the first metal layer 500 is formed by a sputtering process using aluminum neodymium as a target material or a chemical vapor deposition (CVD) process. The first metal layer 500 is formed in all of a display area DA, a first peripheral area PA1 and a second peripheral area PA2 of the first insulation substrate 210.

Referring to FIG. 4B, a second metal layer 510 is formed on the first insulation substrate 210 where the first metal layer 500 is formed. The second metal layer 510 may be formed using chrome. In an example embodiment of the present invention, the second metal layer 510 is formed by a sputtering process using chrome as a target material. The second metal layer 510 is formed in all of the display area DA, the first peripheral area PA1 and the second peripheral area PA2 of the first insulation substrate 210.

A third metal layer 520 is formed on the first insulation substrate 210 where the second metal layer 510 is formed. The third metal layer 520 may be formed using chrome nitride. In an example embodiment of the present invention, the third metal layer 520 is formed by a reactive sputtering process using nitrogen gas. In another example embodiment of the present invention, the third metal layer 520 is formed by a PCVD process using nitrogen gas and ammonia gas. While performing the reactive sputtering process or the PCVD process, the second and the third metal layers 510 and 520 may be formed in the same chamber. Referring to FIG. 5, a reactive sputtering apparatus 600 includes a first chamber 610 for processing the first insulation substrate 210 using argon gas for sputtering and nitrogen gas for nitrating. A first chuck 620 on which the first insulation substrate 210 is installed in the first chamber 610, and a first metal target 630 is positioned above the first chuck 620. Generally, a negative voltage generated by a first power source unit 640 is applied to the first metal target 630.

The reactive sputtering apparatus 600 further includes a first gas supply unit 650, which uniformly supplies gas for processing the first insulation substrate 210 into the first chamber 610. Argon gas is supplied into the first chamber 610 through the gas supply unit 650. While the argon gas is supplied into the first chamber 610, the first chamber 610 is in vacuum state. When a first negative voltage is applied to the first metal target 630, secondary electrons having substantially the same energy as the applied first negative voltage to the first metal target 630 come out of surface portions of the first metal target 630. The secondary electrons hit the argon gas in the first chamber 610, and then the argon gas collides with the first metal target 630.

When an amount of first impulse energy applied to the first metal target 630 is higher than an amount of binding energy between atoms included the first metal target 630, atoms in surface portions of the first metal target 630 come off. The come-off atoms are sputtered onto the first metal layer 500 formed on the first insulation substrate 210, and the sputtered atoms combine with one another to form a thin layer, i.e., the second metal layer 510. Accordingly, the second metal layer 510 including chrome is formed on the first metal layer 500.

After argon gas and nitrogen gas are supplied into the first chamber 610 through the first gas supply unit 650, when a second negative voltage is applied to the first metal target 630, secondary electrons having substantially the same energy as the applied second negative voltage to the first metal target 630 come out of surface portions of the first metal target 630. The secondary electrons hit the argon gas in the first chamber 610, and then the argon gas collides with the first metal target 630.

When an amount of second impulse energy applied to the first metal target 630 is higher than the amount of binding energy between atoms included in the first metal target 630, atoms in surface portions of the first metal target 630 come off. The come-off atoms combine with the nitrogen gas and are sputtered onto the second metal layer 510 formed on the first metal layer 500. The sputtered atoms with the nitrogen gas combine with one another to form a thin layer, i.e., the third metal layer 520. Accordingly, the third metal layer 520 including chrome nitride is formed on the second metal layer 510. Here, the third metal layer 520 including chrome nitride may be formed only on upper portions of the second metal layer 510 by controlling an amount of the nitrogen gas supply and time for supplying the nitrogen gas into the first chamber 610.

Referring to FIG. 6, a PCVD apparatus 700 includes a second chamber 710 for processing the first insulation substrate 210 using plasma. A second chuck 720 on which the first insulation substrate 210 is installed in the second chamber 710, and a second metal target 730 is positioned above the second chuck 720. The second metal target 730 acts an electrode to which a power is applied to transform a supplied gas into plasma. Generally, a high direct current voltage generated by a second power source unit 740 is applied to the second metal target 730.

The PCVD apparatus 700 may further include a second gas supply unit 750, which uniformly supplies gas for processing the first insulation substrate 210 into the second chamber 710. Ammonia gas and/or nitrogen gas are supplied into the second chamber 710 through the second gas supply unit 750. The ammonia gas and the nitrogen gas may be supplied into the second chamber 710 simultaneously or sequentially. Particularly, after ammonia gas is supplied into the second chamber 710 through the second gas supply unit 750, the second metal layer 510 is formed on the first metal layer 500 by plasma discharge occurring in a discharge space 760.

When nitrogen gas is supplied into the second chamber 710 through the second source gas supply unit 750 and then the nitrogen gas and the ammonia gas are transformed into plasma state by plasma discharge occurring in the discharge space 760, nitrogen ions permeate into the second metal layer 510 formed on the first metal layer 500 to complete nitration process. Accordingly, the third metal layer 520 including chrome nitride is formed on the second metal layer 510.

As described above, the second and the third metal layers 510 and 520 are formed in substantially the same chambers 610 and 710, respectively, during each process for forming the second and the third metal layers 510 and 520. Thus, the third metal layer 520 may be formed with the second metal layer 510 not made contact with air. Accordingly, the second metal layer 510 may include pure chrome.

Referring to FIG. 4C, after a photoresist layer 535 is deposited on the first insulation layer 210 where the first, the second and the third metal layers 500, 510 and 520 are formed, an exposure process using a first mask (not shown) and development process are performed. The second and the third metal layers 510 and 520 are simultaneously and partially etched using a first etchant to thereby form a third gate electrode layer 221c and a second gate electrode layer 221b sequentially stacked on the first insulation substrate 210 where the first metal layer 500 is formed in the display area DA, and to thereby form a third gate electrode pad layer 260c and a second gate electrode pad layer 260b sequentially stacked on the first insulation substrate 210 where the first metal layer 500 is formed in the first peripheral area PA1. After performing the exposure process and the development process, a bake process is performed to harden the photoresist layer 535.

Referring to FIG. 4D, the first metal layer 500 is partially etched using a second etchant to thereby form a first gate electrode layer 221a on the first insulation substrate 210 in the display area DA, and to thereby form a first gate electrode pad layer 260a on the first insulation substrate 210 in the first peripheral area PA1. The photoresist layer 535 is removed from the first insulation substrate 210. Accordingly, a gate electrode 221 including the first, the second and the third gate electrode layers 221a, 221b and 221c is formed on the first insulation substrate 210 in the display area DA, and a gate electrode pad 260 including the first, the second and the third gate electrode pad layers 260a, 260b and 260c is formed on the first insulation substrate 210 in the first peripheral area PA1.

The first metal layer 500 from which the first gate electrode layer 221a and the first gate electrode pad layer 260a are formed has no undercut shaped cross section because lower portions of the first metal layer 500 are not more etched than upper portions of the first metal layer 500. Thus, each of the gate electrode 221 and the gate electrode pad 260 has a taper-shaped cross section along a cut line perpendicular to the first insulation substrate 210.

Referring to FIG. 4E, a gate insulation layer 223 is formed on the first insulation substrate 210 where the gate electrode 221 and the gate electrode pad 260 are formed. The gate insulation layer 223 may be formed using silicon nitride (SiNₓ). An active layer 224 is formed on portions of the gate insulation layer 223 beneath which the gate electrode 221 is formed. Particularly, a semiconductor film 224a and an ohmic film 224b are sequentially formed on the portions of the gate insulation layer 223.

A fourth, a fifth and a sixth metal layers 550, 560 and 570 are sequentially formed on the first insulation substrate 210 where the active layer 224 is formed. The fourth and the fifth metal layers 550 and 560 may be formed by a sputtering process or a CVD process. The sixth metal layer 570 may be formed by a reactive sputtering process using the reactive sputtering apparatus 600 shown in FIG. 5 or a PCVD process using the PCVD apparatus 700 shown in FIG. 6. The fifth and the sixth metal layers 560 and 570 may be formed in substantially the same chamber. The fourth metal layer 550 may be formed using aluminum neodymium, the fifth metal layer 560 may be formed using chrome, and the sixth metal layer 570 may be formed using chrome nitride.

Referring to FIG. 4F, after an exposure process using a second mask (not shown) and development process are performed on the first insulation substrate 210 where the fourth, the fifth and the sixth metal layers 550, 560 and 570 are formed, the fifth and the sixth metal layers 560 and 570 are simultaneously and partially etched using the first etchant. Further, the fourth metal layer 550 is partially etched using the second etchant. Thus, a source electrode 225 and a drain electrode 226 are formed in the display area DA, and a data electrode pad 280 is formed in the second peripheral area PA2.

The source electrode 225 includes a first source electrode layer 225a, a second source electrode layer 225b and a third source electrode layer 225c. The drain electrode 226 includes a first drain electrode layer 226a, a second drain electrode layer 226b and a third drain electrode layer 226c. The data electrode pad 280 includes a first data electrode pad layer 280a, a second data electrode pad layer 280b and a third data electrode pad layer 280c.

The fourth metal layer 550 from which the first source electrode layer 225a, the first drain electrode layer 226a, and the first data electrode pad layer 280a are formed has no undercut shaped cross section because lower portions of the fourth metal layer 550 are not more etched than upper portions of the fourth metal layer 550. Thus, each of the source electrode 225, the drain electrode 226, and the data electrode pad 280 has a taper-shaped cross section along a cut line perpendicular to the first insulation substrate 210.

A protecting layer 230 is formed on the first insulation substrate 210 where the source electrode 225, the drain electrode 226 and the data electrode pad 280 are formed. The protecting layer 230 may be formed using silicon nitride. An organic insulation layer 240 is formed on the first insulation substrate 210 where the protecting layer 230 is formed.

Referring to FIG. 4G, a contact hole 245 is formed in the display area DA, a first via hole 265 is formed in the first peripheral area PA1, and a second via hole 285 is formed in the second peripheral area PA2. More particularly, portions of the organic insulation layer 240, the protecting layer 230 and the third drain electrode layer 226c, which are formed in the display area DA, are partially removed to thereby form the contact hole 245 partially exposing the second drain electrode layer 226b in the display area DA. Portions of the organic insulation layer 240, the protecting layer 230, the gate insulation layer 223 and the third gate electrode pad layer 260c, which are formed in the first peripheral area PA1, are partially removed to thereby form the first via hole 265 in the first peripheral area PA1. Portions of the organic insulation layer 240, the protecting layer 230 and the third data electrode pad layer 280c, which are formed in the second peripheral area PA2, are partially removed to thereby form the second via hole 285 in the second peripheral area PA2.

Referring to FIG. 4H, a pixel electrode 250, a first transparent electrode 270 and a second transparent electrode 290 is formed on the organic insulation layer 240. The pixel electrode 250 and the first and the second transparent electrodes 270 and 290 may be formed using ITO or IZO.

The pixel electrode 250 is formed in the display area DA, and is electrically connected to the drain electrode 226 through the contact hole 245. The pixel electrode 250 makes direct contact with the second drain electrode layer 226b. The second drain electrode layer 226b may include pure chrome. Thus, contact resistance between the pixel electrode 250 and the drain electrode 226 may be reduced. The first transparent electrode 270 is formed in the first peripheral area PA1, and is electrically connected to the gate electrode pad 260 through the first via hole 265. The first transparent electrode 270 makes direct contact with the second gate electrode pad layer 260b. The second gate electrode pad layer 260b may include pure chrome. Thus, contact resistance between the first transparent electrode 270 and the gate electrode pad 260 may be reduced. The second transparent electrode 290 is formed in the second peripheral area PA2, and is electrically connected to the data electrode pad 280 through the second via hole 285. The second transparent electrode 290 makes direct contact with the second data electrode pad layer 280b. The second data electrode pad layer 280b may include pure chrome. Thus, contact resistance between the second transparent electrode 290 and the data electrode pad 280 may be reduced.

Example 2 of Method of Forming an Array Substrate

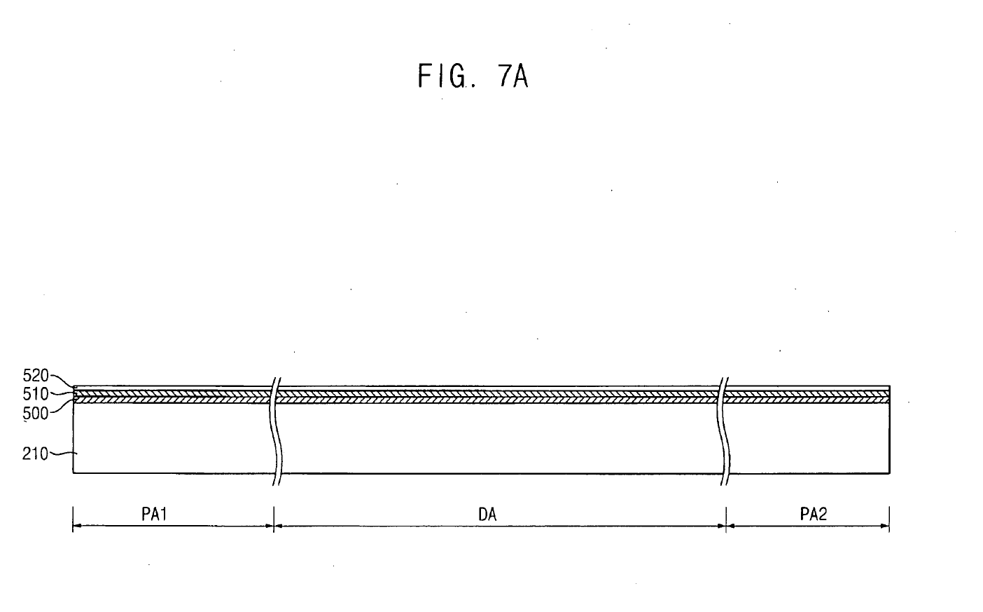

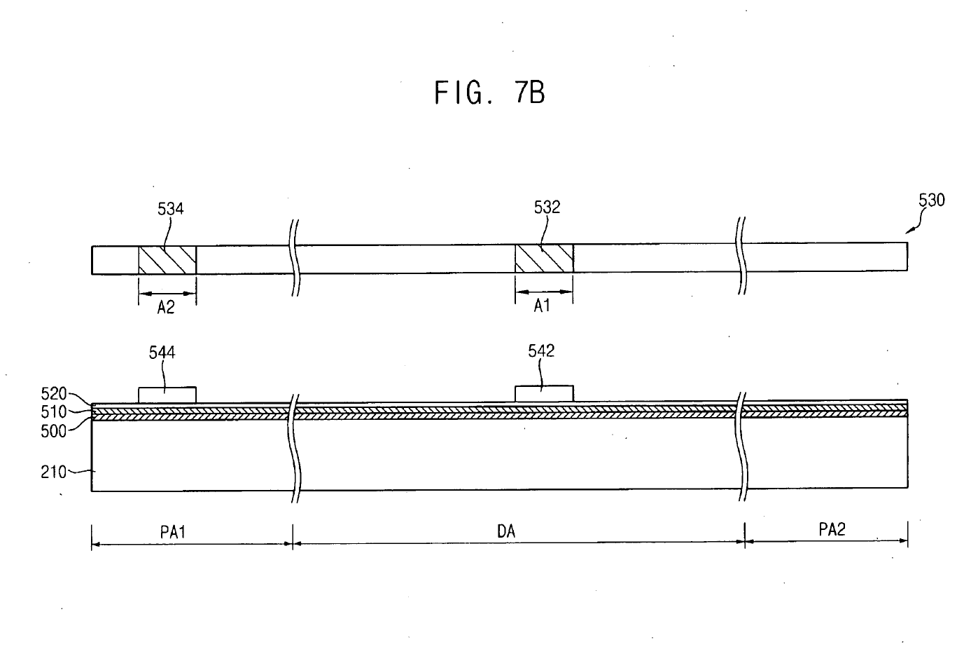

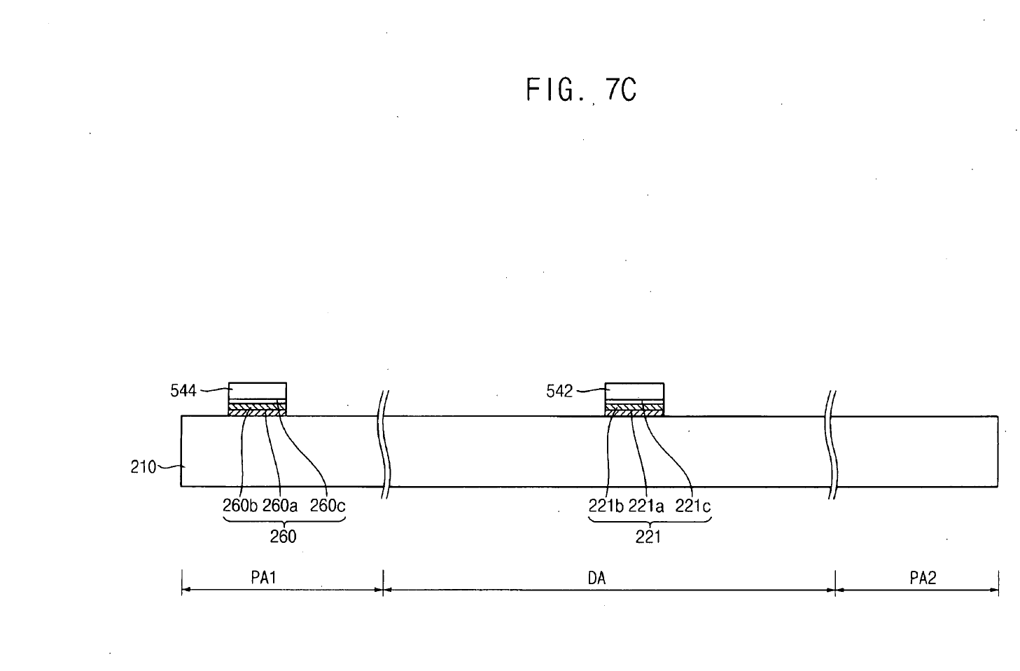

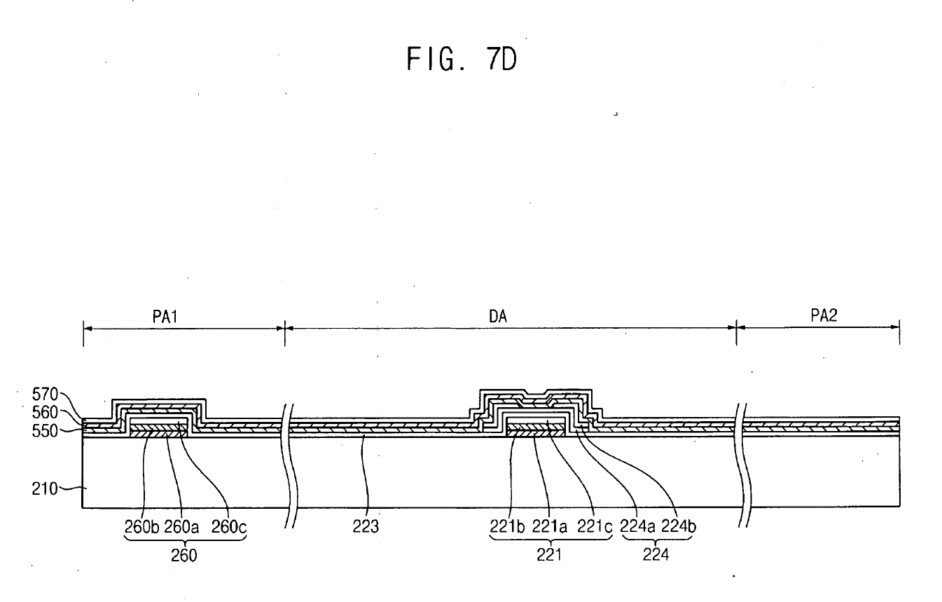

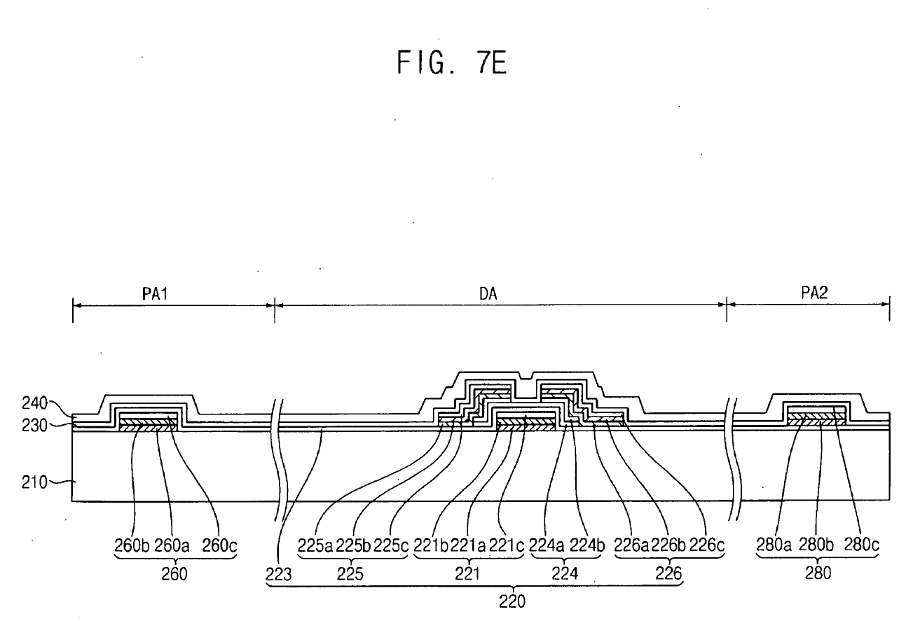

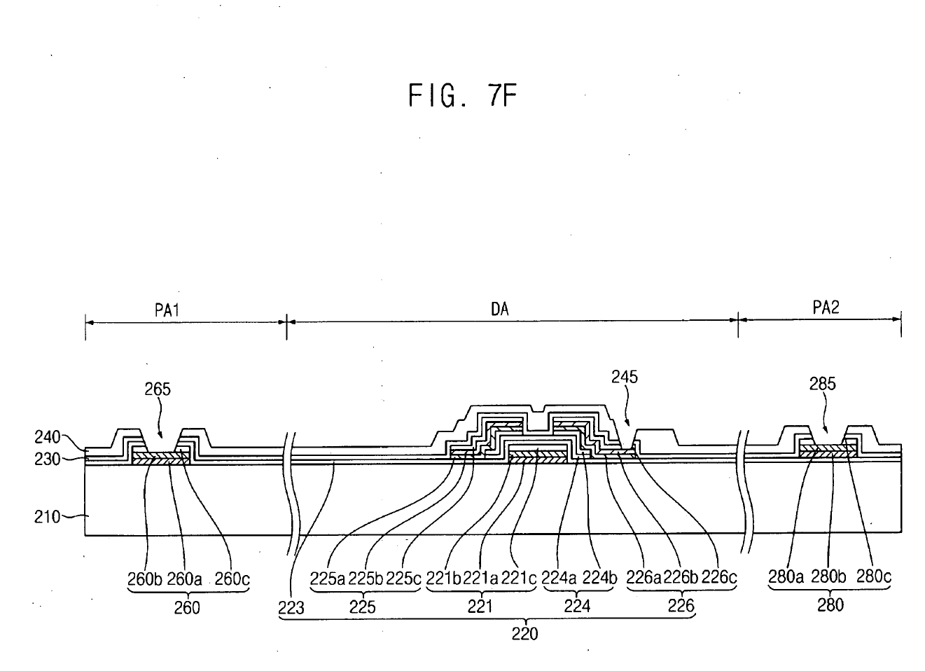

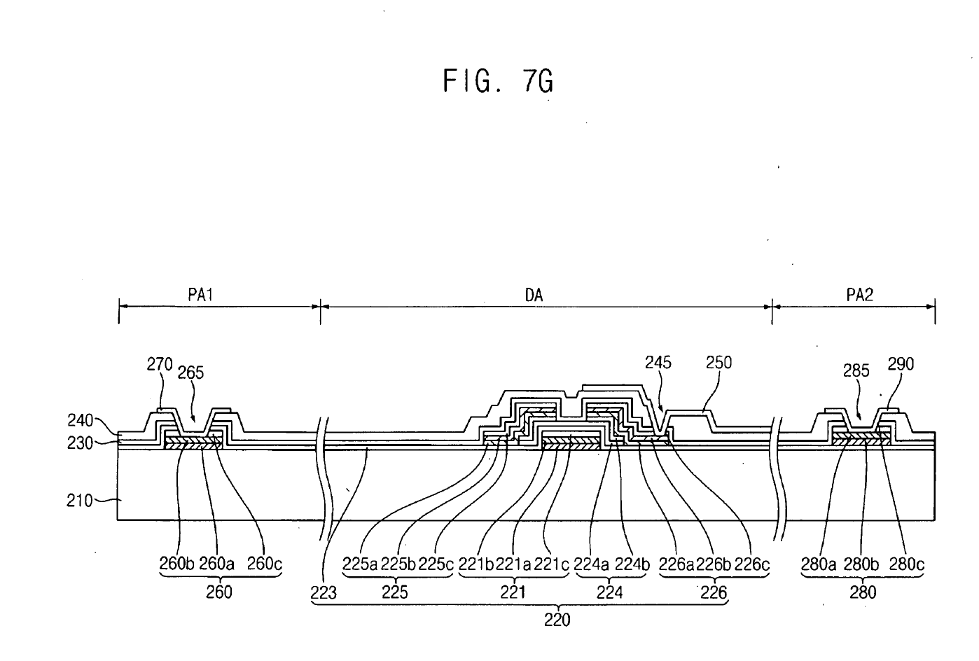

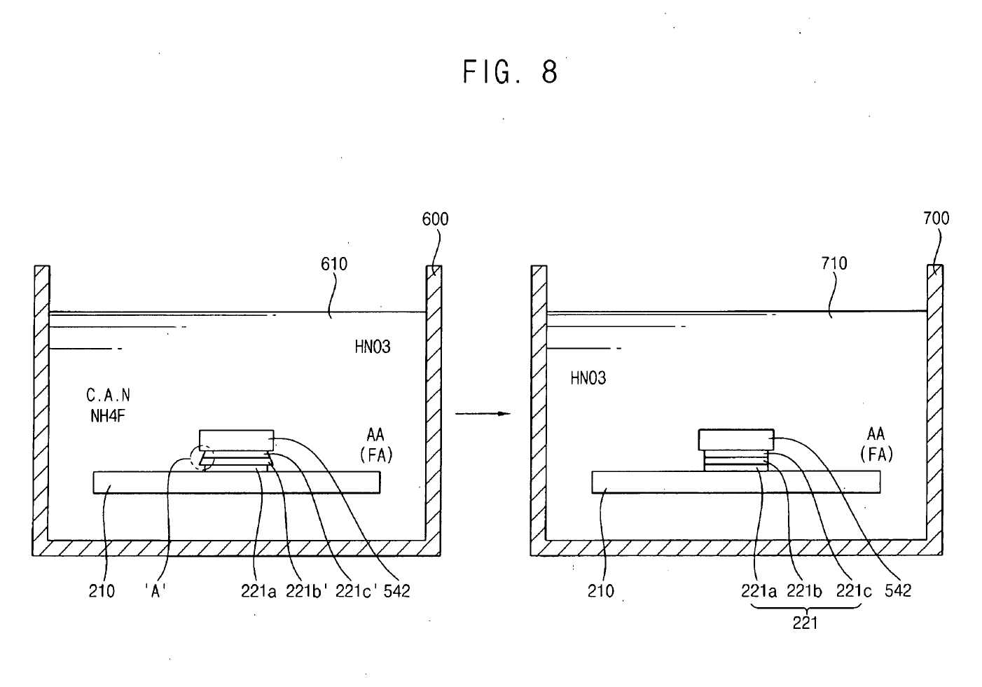

FIGS. 7A to 7G are cross-sectional views illustrating steps for forming the array substrate shown in FIG. 1, and FIG. 8 is a cross-sectional view illustrating etching baths for etching the first, the second metal and the third metal layers shown in FIG. 7C. Referring to FIG. 7A, a first metal layer 500 is formed on a first insulation substrate 210. The first metal layer 500 may be formed using aluminum neodymium. In an example embodiment of the present invention, the first metal layer 500 is formed by a sputtering process using aluminum neodymium as a target material or a chemical vapor deposition (CVD) process.

A second metal layer 510 is formed on the first insulation substrate 210 where the first metal layer 500 is formed. The second metal layer 510 may be formed using chrome. In an example embodiment of the present invention, the second metal layer 510 is formed by a sputtering process using chrome as a target material. A third metal layer 520 is formed on the first insulation substrate 210 where the second metal layer 510 is formed. The third metal layer 520 may be formed using chrome nitride. In an example embodiment of the present invention, the third metal layer 520 is formed by a reactive sputtering process using nitrogen gas. In another example embodiment of the present invention, the third metal layer 520 is formed by a PCVD process using nitrogen gas and ammonia gas. While performing the reactive sputtering process or the PCVD process, the second and the third metal layers 510 and 520 may be formed in the same chamber. The first, the second and the third metal layers 500, 510 and 520 are formed in all of a display area DA, a first peripheral area PA1 and a second peripheral area PA2 of the first insulation substrate 210.

Referring to FIG. 7B, a photoresist layer (not shown) is formed on the first insulation substrate 210 where the first, the second and the third metal layers 500, 510 and 520 are formed. A mask 530 having a pattern is disposed over the first insulation substrate 210 where the photoresist layer is formed. The mask 530 has a first closed portion 532 and a second closed portion 534. The first closed portion 532 of the mask 530 is positioned at a first area A1 corresponding to an area where a gate electrode 221 will be formed later, and the second closed portion 534 of the mask 530 is positioned at a second area A2 corresponding to an area where a gate electrode pad 260 will be formed later.

An exposure process is performed on the first insulation substrate 210 where the photoresist layer is formed using the mask 530. In the exposure process, an exposure light is blocked only at the first and the second areas A1 and A2 corresponding to the first and the second closed portions 532 and 534 of the mask 530, respectively. The photoresist layer is partially etched using an etching solution to thereby form a first photoresist pattern 542 corresponding to the first area A1, and to thereby form a second photoresist pattern 544 corresponding to the second area A2.

Referring to FIG. 7C, the first, the second and the third metal layers 500, 510 and 520 are partially etched using the first and the second photoresist patterns 542 and 544 to thereby form the gate electrode 221 and the gate electrode pad 260. The gate electrode 221 includes a first gate electrode layer 221a, a second gate electrode layer 221b stacked on the first gate electrode layer 221a, and a third gate electrode layer 221c stacked on the second gate electrode layer 221b. The gate electrode pad 260 includes a first gate electrode pad layer 260a, a second gate electrode pad layer 260b stacked on the first gate electrode layer 260a, and a third gate electrode pad layer 260c stacked on the second gate electrode layer 260b. The first gate electrode layer 221a and the first gate electrode pad layer 260a may include aluminum neodymium (AlNd), the second gate electrode layer 221b and the second gate electrode pad layer 260b may include chrome (Cr), and the third gate electrode layer 221c and the third gate electrode pad layer 260c may include chrome nitride (CrNₓ).

The first, the second and the third metal layers 500, 510 and 520 may be simultaneously etched using an etching solution. For example, the etching solution is a mixed etching solution including CAN, nitric acid and ammonium fluoride. CAN and nitric acid may etch chrome and chrome nitride included in the second and the third metal layers 510 and 520. Ammonium fluoride may etch aluminum neodymium included in the first metal layer 500. The mixed etching solution includes about 5 to about 30 percent by weight of CAN, about 2 to about 20 percent by weight of nitric acid, and about 1 to about 5 percent by weight of formic acid or acetic acid.

Hereinafter, patterning process for forming the gate electrode 221 and the gate electrode pad 260 will be described in detail with reference to FIG. 8. Referring to FIG. 8, the first insulation substrate 210 where the first, the second and the third metal layers 500, 510 and 520 are formed is immersed in the first etching bath 600 where a mixed etching solution 610 is contained. In an example embodiment of the present invention, the mixed etching solution 610 includes CAN, nitric acid (HNO₃) and ammonium fluoride (NH₄F). Formic acid (FA) and acetic acid (AA) may be further included in the mixed etching solution 610.

The second and the third metal layers 510 and 520 including chrome and chrome nitride may be etched by the CAN and the nitric acid included in the mixed etching solution 610 to thereby form a second preliminary gate electrode layer 221b′ and a third preliminary gate electrode layer 221c′ on the first metal layer 500. After the second and the third metal layers 510 and the 520 are etched, the first metal layer 500 including aluminum neodymium may be etched by the ammonia fluoride included in the mixed etching solution 610 to thereby form a first gate electrode layer 221a on the first insulation substrate 210. The first metal layer 500 is more etched than the second and the third metal layers 510 and 520 due to the galvanic effect. Thus, protrusive portions may be formed in areas of the second and the third preliminary gate electrode layers 221b′ and 221c′ that make contact with the first photoresist pattern 542 such as an area A.

The first insulation substrate 210 where the first gate electrode layer 221a and the second and the third preliminary gate electrode layers 221b′ and 221c′ are formed is immersed in a second etching bath 700 where a nitric acid (HNO₃) solution 710 is contained. The protrusive portions of the second and the third preliminary gate electrode layers 221b′ and 221c′ may be etched by the nitric acid solution 710 so that the second and the third preliminary gate electrode layers 221b′ and 221c′ are transformed into the second and the third gate electrode layers 221b and 221c, respectively. Thus, the gate electrode 221 including the first, the second and the third gate electrode layers 221a, 221b and 221c is formed on the first insulation substrate 210. The gate electrode 221 has a taper-shaped cross section along a cut line substantially perpendicular to the first insulation substrate 210. Until now, forming the gate electrode 221 has been described, but the gate electrode pad 260 may be formed by substantially the same process as the patterning process for forming the gate electrode 221.

Referring to FIG. 7D, after the first and the second photoresist pattern 542 and 544 are removed, a gate insulation layer 223 is formed on the first insulation substrate 210 where the gate electrode 221 and the gate electrode pad 260 are formed. The gate insulation layer 223 may be formed using silicon nitride (SiNₓ).

An active layer 224 is formed on portions of the gate insulation layer 223 beneath which the gate electrode 221 is formed. Particularly, a semiconductor film 224a and an ohmic film 224b are sequentially formed on the portions of the gate insulation layer 223. A fourth, a fifth and a sixth metal layers 550, 560 and 570 are sequentially formed on the first insulation substrate 210 where the active layer 224 is formed. The fourth, the fifth and the sixth metal layers 550, 560 and 570 may be formed by a sputtering process, a CVD process or a PCVD process. The fourth metal layer 550 may be formed using aluminum neodymium, the fifth metal layer 560 may be formed using chrome, and the sixth metal layer 570 may be formed using chrome nitride.

Referring to FIG. 7E, after an exposure process using a mask (not shown) and development process is performed on the first insulation substrate 210 where the fourth, the fifth and the sixth metal layers 550, 560 and 570 are formed, the fourth, the fifth and the sixth metal layers 550, 560 and 570 are partially etched using the mixed etching solution. Thus, a source electrode 225 and a drain electrode 226 are formed in the display area DA, and a data electrode pad 280 is formed in the second peripheral area PA2.

A protecting layer 230 is formed on the first insulation substrate 210 where the source electrode 225, the drain electrode 226 and the data electrode pad 280 are formed. The protecting layer 230 may be formed using silicon nitride. An organic insulation layer 240 is formed on the first insulation substrate 210 where the protecting layer 230 is formed.

Referring to FIG. 7F, a contact hole 245 is formed in the display area DA, a first via hole 265 is formed in the first peripheral area PA1, and a second via hole 285 is formed in the second peripheral area PA2. More particularly, portions of the organic insulation layer 240, the protecting layer 230 and the third drain electrode layer 226c, which are formed in the display area DA, are partially removed to thereby form the contact hole 245 partially exposing the second drain electrode layer 226b in the display area DA. Portions of the organic insulation layer 240, the protecting layer 230, the gate insulation layer 223 and the third gate electrode pad layer 260c, which are formed in the first peripheral area PA1, are partially removed to thereby form the first via hole 265 in the first peripheral area PA1. Portions of the organic insulation layer 240, the protecting layer 230 and the third data electrode pad layer 280c, which are formed in the second peripheral area PA2, are partially removed to thereby form the second via hole 285 in the second peripheral area PA2.

Referring to FIG. 7G, a pixel electrode 250, a first transparent electrode 270 and a second transparent electrode 290 is formed on the organic insulation layer 240. The pixel electrode 250 and the first and the second transparent electrodes 270 and 290 may be formed using ITO or IZO. The pixel electrode 250 is formed in the display area DA, and is electrically connected to the drain electrode 226 through the contact hole 245.

A first transparent electrode 270 is formed in the first peripheral area PA1, and is electrically connected to the gate electrode pad 260 through the first via hole 265. The second transparent electrode 290 is formed in the second peripheral area PA2, and is electrically connected to the data electrode pad 280 through the second via hole 285.

As described above, the gate electrode 221, the source electrode 225, the drain electrode 226, the gate electrode pad 260 and the data electrode pad 280 having the triple-layered structure are patterned by one process using the mixed etching solution so that a manufacture process may be simplified.

Until now, a method of forming a triple-layered structure having a first metal layer including aluminum neodymium, a second metal layer including chrome and a third metal layer including chrome nitride sequentially formed on an insulation substrate has been illustrated, but the present invention may be adapted to a method of forming a triple-layered structure having a first metal layer including chrome, a second metal layer including chrome nitride and a third metal layer including aluminum neodymium sequentially formed on an insulation substrate. In addition, the present invention may be adapted to a method of forming a double-layered structure having a first metal layer including aluminum neodymium and a second metal layer including chrome.

Example Embodiment of an LCD Device

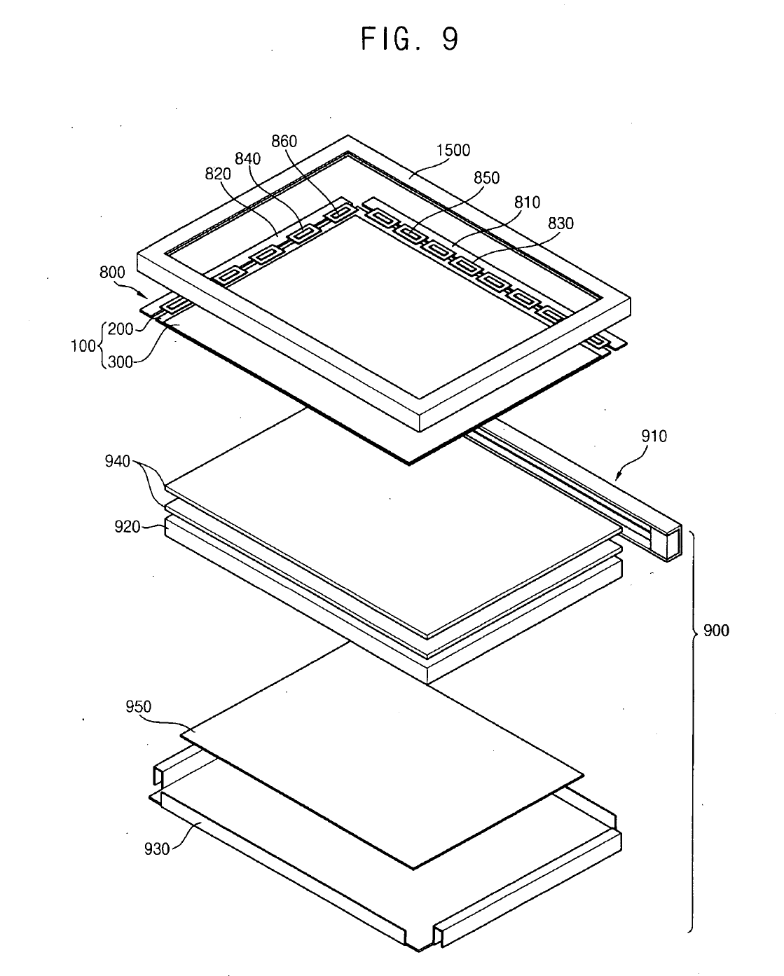

FIG. 9 is an exploded prospective view illustrating an LCD device having an LCD panel in accordance with an example embodiment of the present invention. Referring to FIG. 9, the LCD device includes a display unit 800 and a backlight assembly 900 formed under the display unit 800. The display unit 800 includes an LCD panel 100, a source printed circuit board (PCB) 810 and a gate PCB 820. The LCD panel 100 displays an image. The source PCB 810 and the gate PCB 820 generate driving signals for driving the LCD panel 100. The driving signals generated from the source PCB 810 and the gate PCB 820 are applied to the LCD panel 100 through a data flexible circuit film 830 and a gate flexible circuit film 840, respectively. Each of the data and the gate flexible circuit films 830 and 840 may be a tape carrier package (TCP) or a chip on film (COF). Each of the data and the gate flexible circuit films 830 and 840 further includes a data driving chip 850 and a gate driving chip 860 which control timing of the driving signals generated from the source and the gate PCBs 810 and 820 for applying the driving signals to the LCD panel at a proper time. The LCD panel 100 is substantially the same as the LCD panel shown in FIGS. 1 and 2, thus the same members are denoted by the same reference numeral and repetitive explanations thereof will be omitted.

The backlight assembly 900 includes a lamp unit 910, a light guide plate 920 and a receiving container 930. The lamp unit 910 generates light. The light guide plate 920 controls a path of the light and guides the light to the LCD panel 100. The receiving container 930 receives the lamp unit 910 and the light guiding plate 920. The backlight assembly 900 may further include an optical sheet 940 and a reflective sheet 950. The optical sheet 940 is disposed over the light guide plate 920 and enhances optical characteristics of the light provided from the light guide plate 920. The reflective sheet 950 is disposed under the light guide plate 920, and reflects light that exits the light guiding plate 920 toward the display unit 800.

When the reflective sheet 950 is received in the receiving container 930, the light guide plate 920 and the lamp unit 910 are received over the reflective sheet 950 in the receiving container 930. The optical sheet 940 and the LCD panel 100 are sequentially received over the light guide plate 920 in the receiving container 930. The data flexible circuit film 830 is bent toward a side portion or a bottom portion of the receiving container 930 so that the source PCB 810 may be fixed to a side portion or the bottom portion of the receiving container 930. A top chassis 1500 is disposed over the LCD panel 100. The top chassis 1500 faces the receiving container 930 and fixes the LCD panel to the receiving container 930.

According to the above-mentioned LCD device, the gate electrode 221, the source electrode 225, the drain electrode 226, the gate electrode pad 260 and the data electrode pad 280 may not have any undercut shaped cross sections. In addition, the pixel electrode 250 or the first and the second transparent electrodes 270 and 290 including ITO or IZO make direct contact with chrome so that contact resistance may be reduced.

According to the present invention, a gate electrode, a source electrode, a drain electrode, a gate electrode pad and a data electrode pad have a triple-layered structure in which a first metal layer including aluminum neodymium, a second metal layer including chrome, and a third metal layer including chrome nitride are sequentially stacked.

While forming the electrodes and the pads, after the first metal layer including aluminum neodymium is patterned, the second and the third metal layers including chrome and chrome nitride are patterned so that the undercut phenomenon is prevented from occurring. Thus, the local charge trapping effect is not generated so that failures such as occurrence of lateral stripes may be prevented from occurring and that display quality of the LCD device may be enhanced.

In addition, when a pixel electrode makes contact with the drain electrode and when a transparent electrode makes contact with the gate electrode pad or the data electrode pad, ITO or IZO makes direct contact with pure chrome so that contact resistance may be reduced. Thus, deterioration of display quality may be prevented. Further, the first, the second and the third metal layers having the triple-layered structure may be simultaneously etched by one process using a mixed etching solution including an etching solution for etching aluminum neodymium and an etching solution for etching chrome and chrome nitride. Thus, number of patterning processes for forming the electrodes and the pads may be reduced so that a total process for manufacturing the LCD device may be simplified.

Although example embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. An array substrate comprising:
a substrate having a display area and a peripheral area surrounding the display area; and
a switching device formed on the display area and having a gate electrode, a source electrode and a drain electrode, wherein the gate electrode includes a first metal layer, a second metal layer stacked on the first metal layer, and a third metal layer stacked on the second metal layer, and wherein the third metal layer is formed by nitrating the second metal layer.

2. The array substrate of claim 1, wherein the first metal layer comprises aluminum neodymium (AlNd), wherein the second metal layer comprises chrome (Cr), and wherein the third metal layer comprises chrome nitride (CrNₓ).

3. The array substrate of claim 1, further comprising:
a first electrode pad extended from the gate electrode and formed on the peripheral area, the first electrode pad including the first metal layer, the second metal layer stacked on the first metal layer, and the third metal layer stacked on the second metal layer;
a first insulation layer formed on the first electrode pad; and
a first transparent electrode formed on the first insulation layer, the first transparent electrode electrically connected to the second metal layer of the first electrode pad through a first via hole, wherein the first via hole is formed through the first insulation layer and the third metal layer.

4. The array substrate of claim 3, wherein the first electrode pad is a gate electrode pad supplying the switching device with gate signals.

5. The array substrate of claim 1, wherein the gate electrode has at least one taper-shaped cross section along a cut line substantially perpendicular to the substrate.

6. The array substrate of claim 1, wherein each of the source electrode and the drain electrode comprises a fourth electrode, a fifth electrode stacked on the fourth electrode, and a sixth electrode stacked on the fifth electrode, and wherein the fourth, the fifth and the sixth metal layers include substantially the same material as the first, the second and the third metal layers, respectively.

7. The array substrate of claim 6, wherein the fourth metal layer comprises aluminum neodymium (AlNd), wherein the fifth metal layer comprises chrome (Cr), and wherein the sixth metal layer comprises chrome nitride (CrNₓ).

8. The array substrate of claim 6, further comprising:
a second insulation layer formed on the switching device; and
a pixel electrode formed on the second insulation layer, the pixel electrode electrically connected to the switching device through a contact hole, wherein the contact hole is formed through the second insulation layer and the sixth metal layer.

9. The array substrate of claim 6, further comprising:
a second electrode pad extended from the source electrode and formed on the peripheral area, the second electrode including the fourth metal layer, the fifth metal layer stacked on the fourth metal layer, and the sixth metal layer stacked on the fifth metal layer;
a third insulation layer formed on the second electrode pad; and
a second transparent electrode formed on the third insulation layer, the second transparent electrode electrically connected to the fifth metal layer of the second electrode pad through a second via hole, wherein the second via hole is formed through the third insulation layer and the sixth metal layer.

10. The array substrate of claim 9, wherein the second electrode pad is a data electrode pad supplying the switching device with data signals.

11. The array substrate of claim 6, wherein each of the data electrode and the drain electrode has at least one taper-shaped cross section along a cut line substantially perpendicular to the substrate.

12. An array substrate comprising:
a substrate having a display area and a peripheral area surrounding the display area;
a switching device formed on the display area and having a first electrode, a second electrode and a third electrode;
an electrode pad extended from one of the first, the second and the third electrodes and formed on the peripheral area, the electrode pad including a first metal layer, a second metal layer stacked on the first metal layer, and a third metal layer stacked on the second metal layer, wherein the third metal layer is formed by nitrating the second metal layer;
an insulation layer formed on the electrode pad; and
a transparent electrode formed on the insulation layer, the transparent electrode electrically connected to the second metal layer through a via hole, wherein the via hole is formed through the insulation layer and the third metal layer.

13. The array substrate of claim 12, wherein at least one of the first, the second and the third electrodes of the switching device comprises the first, the second and the third metal layer sequentially stacked.

14. The array substrate of claim 12, wherein the first metal layer comprises aluminum neodymium, the second metal layer comprises chrome, and the third metal layer comprises chrome nitride.

15. The array substrate of claim 12, wherein the electrode pad has a taper-shaped cross section along a cut line substantially perpendicular to the substrate.

16. An array substrate comprising:
a substrate having a display area and a peripheral area surrounding the display area;
a switching device formed on the display area and having a first electrode, a second electrode and a third electrode, wherein at least one of the first, the second and the third electrodes includes a first metal layer, a second metal layer stacked on the first metal layer, and a third metal layer stacked on the second metal layer, and wherein the third metal layer is formed by nitrating the second metal layer;
an electrode pad extended from one of the first, the second and the third electrodes and formed on the peripheral area, the electrode pad including the first metal layer, the second metal layer stacked on the first metal layer, and the third metal layer stacked on the second metal layer;
an insulation layer formed on the substrate where the switching device and the electrode pad are formed;
a first transparent electrode formed on the insulation layer, the first transparent electrode electrically connected to the second metal layer through a contact hole, wherein the contact hole is formed through the insulation layer and the third metal layer of the one of the first, the second and the third electrodes; and
a second transparent electrode formed on the insulation layer, the second transparent electrode electrically connected to the second metal layer through a via hole, wherein the via hole is formed through the insulation layer and the third metal layer of the electrode pad.

17. The array substrate of claim 16, wherein the first metal layer comprises aluminum neodymium, the second metal layer comprises chrome, and the third metal layer comprises chrome nitride.

18. An array substrate comprising:
a substrate;
a first signal line formed on the substrate and including a first metal layer, a second metal layer stacked on the first metal layer, and a third metal layer stacked on the second metal layer, wherein the third metal layer is formed by nitrating the second metal layer;
an insulation layer formed on the first line signal; and
a second signal line formed on the insulation layer to cross the first signal line.

19. The array substrate of claim 18, wherein the second signal line comprises a fourth metal layer, a fifth metal layer stacked on the fourth layer, and a sixth metal layer stacked on the fifth metal layer, and wherein the fourth, the fifth and the sixth metal layers include substantially the same material as the first, the second and the third metal layers, respectively.

20. The array substrate of claim 18, further comprising:
a switching device including a first electrode, a second electrode and a third electrode, wherein the first, the second and the third electrodes are electrically connected to the first and the second signal lines; and
a pixel electrode electrically connected to the switching device,
wherein at least one of the first, the second and the third electrodes includes the first, the second and the third metal layers sequentially stacked on the substrate,
and wherein the pixel electrode is electrically connected to the second metal layer of the switching device through a contact hole, the contact hole is formed through the insulation layer and the third metal layer.

21. The array substrate of claim 18, further comprising:
an electrode pad extended from one of the first and the second signal lines and including the first, the second and the third metal layers sequentially stacked on the substrate; and
a transparent electrode formed on the insulation layer, the transparent electrode electrically connected to the second metal layer of the electrode pad through a via hole, wherein the via hole is formed through the insulation layer and the third metal layer of the electrode.

22. The array substrate of claim 18, wherein the first metal layer comprises aluminum neodymium (AlNd), the second metal layer comprises chrome (Cr), and the third metal layer comprises chrome nitride (CrNₓ).

23. An array substrate comprising:
a substrate having a display area and a peripheral area surrounding the display area;
a switching device formed on the display area and having a first electrode, a second electrode and a third electrode, wherein at least one of the first, the second and the third electrodes includes a first metal layer and a second metal layer stacked on the first metal layer, and wherein the second metal layer is nitrated to have nitrogen ions in an upper portion; and
a pixel electrode electrically connected to one of the first, the second and the third electrodes of the switching device.

24. The array substrate of claim 23, wherein the first metal layer comprises aluminum neodymium (AlNd) and the second metal layer comprises chrome (Cr).

25. The array substrate of claim 23, further comprising:
an electrode pad extended from one of the first, the second and the third electrodes and formed on the peripheral area, the electrode pad including a first metal layer and a second metal layer stacked on the first metal layer; and
a transparent electrode formed on the electrode pad and electrically connected to the electrode pad.

26. A method of forming an array substrate comprising:
forming a switching device on a display area of a substrate, wherein the switching device has a first electrode, a second electrode and a third electrode, wherein at least one of the first, the second and the third electrodes has a first metal layer, a second metal layer stacked on the first metal layer, and a third metal layer stacked on the second metal layer, and wherein the third metal layer is formed by nitrating the second metal layer;
forming an insulation layer on the substrate where the switching device is formed; and
forming a pixel electrode on the insulation layer to be electrically connected to the second metal layer of the switching device through a contact hole, the contact hole is formed through the insulation layer and a portion of the third electrode.

27. The method of claim 26, wherein the first metal layer is formed using aluminum neodymium (AlNd), wherein the second metal layer is formed using chrome (Cr), and wherein the third metal layer is formed using chrome nitride (CrNₓ).

28. The method of claim 26, wherein forming the switching device comprises:
forming the first metal layer on the substrate in a first chamber;
forming the second metal layer on the substrate where the first metal layer is formed in a second chamber;
forming the third metal layer on the second metal layer by providing nitrogen gas into the second chamber; and
forming the first, the second and the third electrodes by patterning the first, the second and the third metal layers.

29. The method of claim 28, wherein forming the first, the second and the third electrodes comprises:
simultaneously patterning the second and the third metal layers; and
patterning the first metal layer.

30. The method of claim 28, wherein the second chamber is in vacuum state.

31. The method of claim 26, further comprising forming the contact hole by simultaneously removing the insulation layer and the third metal layer, the contact hole exposing a portion of the second metal layer.

32. The method of claim 31, wherein the third metal layer and the insulation layer are etched by substantially the same etching solution.

33. The method of claim 26, further comprising:
forming an electrode pad on a peripheral area surrounding the display area, the electrode pad is extended from one of the first, the second and the third electrodes and includes the first, the second and the third metal layers sequentially stacked on the substrate; and
forming a transparent electrode on the insulation layer to be electrically connected to the second metal layer of the electrode pad through a via hole, the via hole is formed through the insulation layer and the third metal layer of the electrode.

34. The method of claim 33, further comprising forming the via hole by simultaneously and partially etching the insulation layer and the third metal layer of the electrode pad, the via hole exposing a portion of the second metal layer of the electrode pad.

35. A method of forming an array substrate comprising:
forming a first metal layer on a substrate using aluminum alloy;
forming a second metal layer on the first metal layer using chrome;
etching the first and the second metal layers using a mixed etching solution, wherein the mixed etching solution includes a first etching solution for etching the first metal layer and a second etching solution for etching the second metal layer; and
etching the second metal layer using a third etching solution, the second metal layer remaining after being etched using the mixed etching solution.

36. The method of claim 35, wherein the first etching solution comprises ammonium fluoride (NH₄F) and wherein the second etching solution comprises ceric ammonium nitrate (CAN) and nitric acid (HNO₃).

37. The method of claim 36, wherein the mixed etching solution includes about 2 to about 30 percent by weight of ammonium fluoride, about 5 to about 30 percent by weight of CAN, and about 2 to about 20 percent by weight of nitric acid.

38. The method of claim 35, wherein the third etching solution comprises nitric acid.

39. The method of claim 35, wherein the mixed etching solution further includes formic acid or acetic acid.

40. The method of claim 39, wherein the mixed etching solution includes about 1 to about 5 percent by weight of formic acid or acetic acid.

41. The method of claim 35, wherein forming the first and the second metal layer further comprises forming a third metal layer on the second metal layer using chrome nitride.

42. The method of claim 35, wherein the aluminum alloy is aluminum neodymium.

43. A display device comprising:
a first substrate having a transparent electrode;
a second substrate facing the first substrate, the array substrate comprising:
a switching device having a first electrode, a second electrode and a third electrode, wherein at least one of the first, the second and the third electrodes having a first metal layer, a second metal layer, and a third metal layer, and wherein the third metal layer is formed by nitrating the second metal layer;
an insulation layer formed on the switching device;
a second transparent electrode facing the first transparent electrode, the second transparent electrode electrically connected to the second metal layer of the switching device through a contact hole, wherein the contact hole is formed through the insulation layer and the third metal layer of the switching device;
an electrode pad extended from one of the first, the second and the third electrodes and having the first, the second and the third metal layers; and
a third transparent electrode electrically connected to the second metal layer of the electrode pad through a via hole, wherein the via hole is formed through the insulation layer and the third metal layer of the electrode; and
a liquid crystal layer interposed between the first and the second substrate.

44. The display device of claim 43, wherein the first metal layer comprises aluminum neodymium (AlNd), the second metal layer comprises chrome (Cr), and the third metal layer comprises chrome nitride (CrNₓ).
